(19) United States
(12) Patent Application Publication
(10) Pub. No.: US 2017/0350479 A1
(43) Pub. Date: Dec. 7, 2017

(54) Electric Actuator

(71) Applicant: NTN Corporation, Osaka-shi (JP)

(72) Inventor: Tatsunori SHIMIZU, Iwata-shi (JP)

(21) Appl. No.: 15/666,662

(22) Filed: Aug. 2, 2017

Related U.S. Application Data
(63) Continuation of application No. PCT/JP2016/052941, filed on Feb. 1, 2016.

(30) Foreign Application Priority Data
Feb. 2, 2015 (JP) 2015-018666

(51) Int. Cl. F16H 25/20; F16H 25/22; C22C 38/42; C22C 38/04; C22C 38/02; C22C 33/02; C22C 38/44; B22F 3/22

(52) U.S. Cl. CPC F16H 25/2015; F16H 25/2204; C22C 38/42; B22F 3/225; C22C 38/02; C22C 33/02; C22C 38/44; C22C 38/04

(57) ABSTRACT

An electric actuator has a housing, an electric motor mounted on the housing, a speed reduction mechanism, and a ball screw mechanism that converts the rotational motion of the electric motor to axial linear motion of a drive shaft. An annular groove is formed on an open end of the blind bore of the housing. The sleeve is axially immovably secured by a annular stopper ring fit into the annular groove. The stopper ring has one notch and a recess formed on its inner circumference near each of its two ends of the stopper ring. A contour of each recess has a circular arc portion and a flat portion. The circular arc portion has a predetermined radius of curvature. The flat portion tangentially extends from the circular arc portion. A width of the opening of the recess is smaller than a diameter of the circular arc portion.

### CROSS-REFERENCE TO RELATED APPLICATIONS

This application is a continuation of International Application No. PCT/JP2016/052941, filed Feb. 1, 2016, which claims priority to Japanese Application No. 2015-018666, filed Feb. 2, 2015. The disclosures of the above applications are incorporating herein by reference.

### FIELD

The present disclosure relates to electric actuators used in motors in general industries and driving sections of automobiles etc. to convert a rotary motion from an electric motor to linear motion of a driving shaft, via the ball screw mechanism.

### BACKGROUND

Generally, gear mechanisms, such as a trapezoidal thread worm gear mechanisms or rack and pinion gear mechanisms, are used as the mechanism to convert a rotary motion, of an electric motor, to axial linear motion in an electric linear actuator, used in various kinds of driving sections. These motion converting mechanisms involve sliding contact portions. Thus, power loss is increased and, simultaneously, size of the electric motor and power consumption are also increased. Thus, the ball screw mechanisms have been widely used as more efficient actuators.

For example, in a prior art electric actuator, an output member connected to a nut can be axially moved by rotating a ball screw shaft, forming a ball screw mechanism, using an electric motor mounted on a housing. Since friction of the ball screw mechanism is very low and the ball screw shaft tends to be easily rotated by thrust loads acting on the output member, it is necessary to hold the position of the output member when the electric motor is stopped.

For example, the electric motor is provided with a brake or a power transmitting element, of low mechanical efficiency such as a worm gear, to solve such a problem. A representative electric actuator 50 is shown in FIG. 8. The electric actuator 50 has a ball screw mechanism 53 including a ball screw shaft 51, rotationally driven by an electric motor (not shown), and a ball screw nut 52, mated with the ball screw shaft 51 via balls (not shown). When a motor shaft (not shown) of the electric motor is rotated, the ball screw shaft 51, connected to the motor shaft, is rotated and linearly moves the ball screw nut 52 in left and right directions.

The ball screw shaft 51 is rotationally supported on cylindrical housings 54, 55, via two rolling bearings 56, 57. These rolling bearings 56, 57 are secured by a rotation locking member 59. The locking member 59 prevents loosening via a securing cover 58.

The ball screw shaft 51 is formed, on its outer circumference, with a helical screw groove 51a. The helical screw groove 51a mates with the ball screw nut 52, via balls. The ball screw nut 52 is also formed, on its inner circumference, with a helical screw groove 52a. The nut has, on its end, a larger diameter portion 60.

Flat portions 61 are formed on the outer circumference of the larger diameter portion 60. A cam follower (rotation locking mechanism) 62 projects radially outward from the flat portion 61 substantially at its center.

Since the cam follower 62 is fit into a notched portion, entrapment of the ball screw nut 52 accompanied with rotation of the ball screw shaft 51 are prevented. In addition, since the cam follower 62 can rotationally slide relative to the notched portion, sliding friction and sliding wear can be reduced (e.g., see JP2007-333046 A).

While the above prior art electric actuator 50 has these advantages and is able to achieve the lower driving torque, a problem exists in that it increases the manufacturing cost due to the use of rolling bearings in the cam follower. In addition, an anti-wear member is required when the housing 54 uses aluminum material.

Further, a simple structure electric actuator 63, shown in FIG. 9, has been proposed in order to reduce the sliding friction, wear and its manufacturing cost. The electric actuator 63 includes a cylindrical housing 64, an electric motor 65 mounted on the housing 64, a speed reduction mechanism 68 and a ball screw mechanism 70. The speed reduction mechanism 68 includes a pair of spur gears 66, 67 to transmit the rotational power of the electric motor 65, via a motor shaft 65a. The ball screw mechanism 70 converts the rotational motion of the electric motor 65 into the axial linear motion of a driving shaft 69.

The housing 64 is formed from aluminum alloy such as A 6063 TE, ADC 12 etc. It has a first housing 64a and a second housing 64b abutted and bolted to an end face of the first housing 64a, by securing bolts (not shown). The electric motor 65 is mounted on the first housing 64a. The first housing 64a and the second housing 64b form a blind bore 71 and a through bore 72, respectively, to accommodate a screw shaft 74.

A smaller spur gear 66 is press-fit onto the end of the motor shaft 65a of the electric motor 65. A larger spur gear 67 is integrally formed with a nut 73. The nut 73 forms part of the ball screw mechanism 70. The larger spur gear 67 meshes with the smaller spur gear 66. The drive shaft 69 is integrated with the screw shaft 74 to form part of the ball screw mechanism 70.

The ball screw mechanism 70 includes the screw shaft 74 and the nut 73 inserted onto the screw shaft 74, via balls 75. The screw shaft 74 is formed, on its outer circumference, with a helical screw groove 74a. The screw shaft 74 is axially movably supported, but not rotationally. The nut 73 is formed, on its inner circumference, with screw groove 73a, that corresponds to the screw groove 74a of the screw shaft 74. A large number of balls 75 are rollably contained between the screw grooves 73a and 74a. The nut 73 is rotationally supported by two supporting bearings 76, 77, but is axially immovably supported relative to the housing 64.

A cylindrical sleeve 78 is fit into the blind bore 71 of the first housing 64a. The sleeve 78 is formed from sintered alloy formed by an injection molding machine with plastically prepared metallic powder. During the injection molding, metallic powder and binder, with plastics and wax, are firstly mixed and kneaded by a mixing and kneading machine. This forms pellets from the mixed and kneaded material. The pellets are fed into a hopper of the injection molding machine. The molten material is pushed into dies under a heated and melted state and finally forms the sleeve by a so-called MIM (Metal Injection Molding) method.

The sleeve 78 is formed with a pair of diametrically opposite positioned axially extending recessed grooves 78a. A guide pin 80 is fit into a radially through aperture 79 formed at the end of the screw shaft 74. An annular groove 81 is formed on the open end of the blind bore 71 of the housing 64a. The sleeve 78 is axially immovably secured by an annular stopper ring 82 fit into the annular groove 81. The side surfaces of the stopper ring 82 are not flat similar to a usual C-shaped stopper ring. It has a bent cross-section with a vertex at a central position symmetric about a notch of the stopper ring 82.

The rotation locking mechanism is constituted by the guide pin 80 and the sleeve 78, of sintered metal fit, into the first housing 64a of aluminum light alloy. Thus, it is possible to reduce the sliding friction and wear of the aluminum housing 64a as well as the manufacturing cost due to its simple structure.

In addition, axial movement of the sleeve 78 is prevented by the urging spring force of the stopper ring 82 against the sleeve 78. Thus, the generation of vibration and noise can be prevented (see e.g. JP 2013-167334 A).

However, in the prior art electric actuator 63, a problem exists in that once the stopper ring 82 has been attached to the housing 64, the stopper ring 82 cannot be easily removed from the first housing 64a without damaging the housing 64a. Accordingly, the removal operability and thus the maintenance workability of the electric actuator 63 would be impaired.

### SUMMARY

It is, therefore, an object of the present disclosure to provide an electric actuator that can improve the maintenance workability and reduce the manufacturing cost due to its simple structure.

In order to achieve the object of the present disclosure, an electric actuator comprises a housing formed of aluminum light alloy with an electric motor mounted on the housing. A speed reduction mechanism transmits rotational driving power of the motor to a ball screw mechanism. The ball screw mechanism converts the rotational motion of the electric motor to axial linear motion of a driving shaft. The ball screw mechanism has a nut formed with a helical screw groove on its inner circumference. The nut is rotationally supported by supporting bearings mounted on the housing. The nut is axially immovable relative to the housing. A screw shaft, coaxially integrated with the driving shaft, has a helical screw groove on its outer circumference that corresponds to the helical screw groove of the nut. The screw shaft is inserted into the nut via a plurality of balls. A cylindrical sleeve is fit into a blind bore formed in the housing to accommodate the screw shaft. The sleeve's inner circumference has a pair of diametrically oppositely positioned axially extending recessed grooves to receive a guide pin mounted on one end of the screw shaft. The pin guides the screw shaft so that it is able to move axially, but not rotationally, relative to the housing. An annular groove is formed on the open end of the blind bore of the housing. The sleeve is axially immovably secured by an annular stopper ring fit into the annular groove. The stopper ring is formed with one notch. A recess is formed on the inner circumference of the stopper ring near each of the ends of the stopper ring to enable engagement of a detaching tool. The contour of each recess includes a circular arc portion and a flat portion. The circular arc portion has a predetermined radius of curvature. The flat portion extends tangentially from the circular arc portion. The width of the opening of the recess is smaller than the diameter of the circular arc portion.

The electric actuator housing is formed from aluminum light alloy with an electric motor mounted on the housing. A speed reduction mechanism transmits rotational driving power of the motor to a ball screw mechanism, via a motor shaft. The ball screw mechanism converts the rotational motion of the electric motor to axial linear motion of a driving shaft. The ball screw mechanism includes a nut and a screw shaft. The nut has a helical screw groove on its inner circumference. The nut is rotationally, but axially immovably, supported relative to the housing by supporting bearings mounted on the housing. The screw shaft is coaxially integrated with the driving shaft. A helical screw groove is on the screw shaft outer circumference and corresponds to the helical screw groove of the nut. The screw shaft is inserted in the nut, via a plurality of balls. A cylindrical sleeve is fit into a blind bore formed in the housing to accommodate the screw shaft. The sleeve inner circumference has a pair of diametrically oppositely positioned axially extending recessed grooves to receive a guide pin mounted on one end of the screw shaft. This guides the screw shaft so that it is able to move axially, but not rotationally, relative to the housing. An annular groove is formed on the open end of the blind bore of the housing. The sleeve is axially immovably secured by a annular stopper ring fit into the annular groove. The stopper ring is formed with one notch. A recess is formed on the inner circumference of the stopper ring near each of the two ends of the stopper ring to enable engagement of a detaching tool. The contour of each recess has a circular arc portion and a flat portion. The circular arc portion has a predetermined radius of curvature. The flat portion extends tangentially from the circular arc portion. The width of the opening of the recess is smaller than the diameter of the circular arc portion. Thus, it is possible to provide an electric actuator of simple design and low manufacturing cost. Also, the maintenance operability is improved by enabling a removing tool for the stopper ring to easily engage the recess. Thus, this prevents disengagement from the stopper ring.

The stopper ring has a curved portion formed with at least one vertex at positions symmetric about the notch. The sleeve is securely held under a pressed state by the stopper ring. This makes it possible to generate the axial spring force of the stopper ring against the sleeve. This applies a predetermined pre-pressure to the sleeve and prevents the generation of noise or vibration of the housing.

The recess of the stopper ring has a contour with a circular arc portion formed by a circular arc larger than a semicircle. The flat portion extends tangentially from the circular arc portion. An angle is formed between a horizontal line passing through the center of the circular arc portion and a line passing through the center of the circular arc portion. The edge of the opening opposite to the flat portion is within a range of 20°˜40°.

The recess of the stopper ring has a contour with a semicircular arc portion. The flat portion extends tangentially from the semicircular arc portion. Each of the portions of the opening between a horizontal line passing through the center of the semicircular arc portion and the edge of the opening is formed by a flat surface.

An angle of the radially outer side corner of the end of the stopper ring is formed by an obtuse angle. This makes it possible to prevent the angled portion of the radially outer side corner of the end of the stopper ring from being caught on the groove surface of the annular groove of the housing. Thus, this prevents the housing from being damaged as well as to smoothly perform the removing operation of the stopper ring.

The sleeve is formed of sintered alloy formed by MIM (Metal Injection Molding). This makes it possible to easily form the sleeve with a desirable configuration, dimension and high accuracy even if the sleeve has a complicated configuration.

The electric actuator of the present disclosure comprises a housing formed of aluminum light alloy with an electric motor mounted on the housing. A speed reduction mechanism transmits rotational driving power of the motor to a ball screw mechanism, via a motor shaft. The ball screw mechanism converts the rotational motion of the electric motor to the axial linear motion of a drive shaft. The ball screw mechanism includes a nut and a screw shaft. The nut has a helical screw groove on its inner circumference. The nut is rotationally supported by supporting bearings mounted on the housing. The nut is axially immovable relative to the housing. The screw shaft is coaxially integrated with the drive shaft. The screw shaft has a helical screw groove on its outer circumference that corresponds to the helical screw groove of the nut. The screw shaft is inserted into the nut, via a plurality of balls. A cylindrical sleeve is fit into a blind bore formed in the housing to accommodate the screw shaft. The sleeve inner circumference has a pair of diametrically oppositely positioned axially extending recessed grooves to receive a guide pin mounted on one end of the screw shaft. This guides the screw shaft so that it is able to move axially, but not rotationally, relative to the housing. An annular groove is formed on the open end of the blind bore of the housing. The sleeve is axially immovably secured by a annular stopper ring fit into the annular groove. The stopper ring has one notch and a recess is formed on the inner circumference of the stopper ring near each of the two ends of the stopper ring to enable engagement with a detaching tool. The contour of each recess includes a circular arc portion and a flat portion. The circular arc portion has a predetermined radius of curvature. The flat portion extends tangentially from the circular arc portion. The width of the opening of the recess is smaller than the diameter of the circular arc portion. Thus, it is possible to provide an electric actuator of a simple structure and low manufacturing cost. Also, the maintenance operability is improved by engaging a removing tool for the stopper ring to easily engage the recess. Thus, this prevents disengagement from the stopper ring.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal sectional view of one preferable embodiment of an electric actuator.

FIG. 2 is an enlarged longitudinal sectional view of the ball screw mechanism of FIG. 1.

FIG. 3 is a cross-sectional view taken along a line III-III of FIG. 1.

FIG. 4(a) is a front elevation view of a stopper ring.

FIG. 4(b) is a cross-sectional view of the stopper ring of FIG. 4(a).

FIG. 4(c) is an enlarged view of a IV part of FIG. 4(b).

FIG. 5 is an enlarged view of a V part of FIG. 4(a).

FIG. 6 is an explanatory view of a method for measuring the axial spring load applied to the stopper ring.

FIG. 7 is a partially enlarged view of a modification of the stopper ring of FIG. 5.

FIG. 8 is a longitudinal sectional view of a prior art electric actuator.

FIG. 9 is a longitudinal sectional view of another prior art electric actuator.

### DETAILED DESCRIPTION

An electric actuator has a cylindrical housing formed of aluminum light alloy with an electric motor mounted on the housing. A speed reduction mechanism transmits rotational driving power of the motor to a ball screw mechanism, via a motor shaft. The ball screw mechanism converts the rotational motion of the electric motor to the axial linear motion of a driving shaft. The ball screw mechanism includes a nut and a screw shaft. The nut has a helical screw groove on its inner circumference. The nut is rotationally supported by supporting bearings mounted on the housing. The nut is axially immovably supported relative to the housing. The screw shaft is coaxially integrated with the driving shaft. The screw shaft has a helical screw groove on its outer circumference that corresponds to the helical screw groove of the nut. The screw shaft is inserted into the nut, via a plurality of balls. A cylindrical sleeve is fit into a blind bore formed in the housing to accommodate the screw shaft. The sleeve inner circumference has a pair of diametrically oppositely positioned axially extending recessed grooves to receive a guide pin mounted on one end of the screw shaft. This guides the screw shaft so that it is able to move axially, but not rotationally, relative to the housing. An annular groove is formed on the open end of the blind bore of the housing. The sleeve is axially immovably secured by an annular stopper ring. The stopper ring has a curved portion formed with a vertex at a position symmetric about the notch. The stopper ring is formed with one notch. A recess is formed on the inner circumference of the stopper ring near each end of the stopper ring. This enables engagement of a detaching tool. The contour of each recess includes a circular arc portion and a flat portion. The circular arc portion has a predetermined radius of curvature. The flat portion extends tangentially from the circular arc portion. The width of the opening of the recess is smaller than the diameter of the circular arc portion.

One preferred embodiment of the present disclosure will be hereinafter described with reference to the drawings.

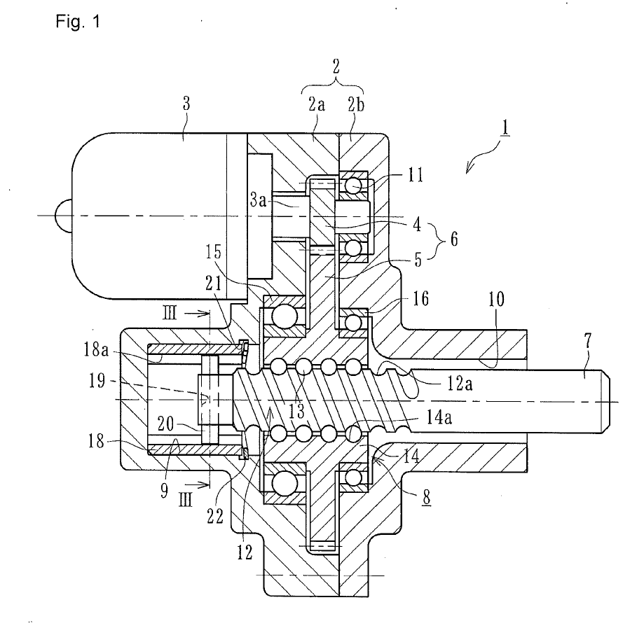

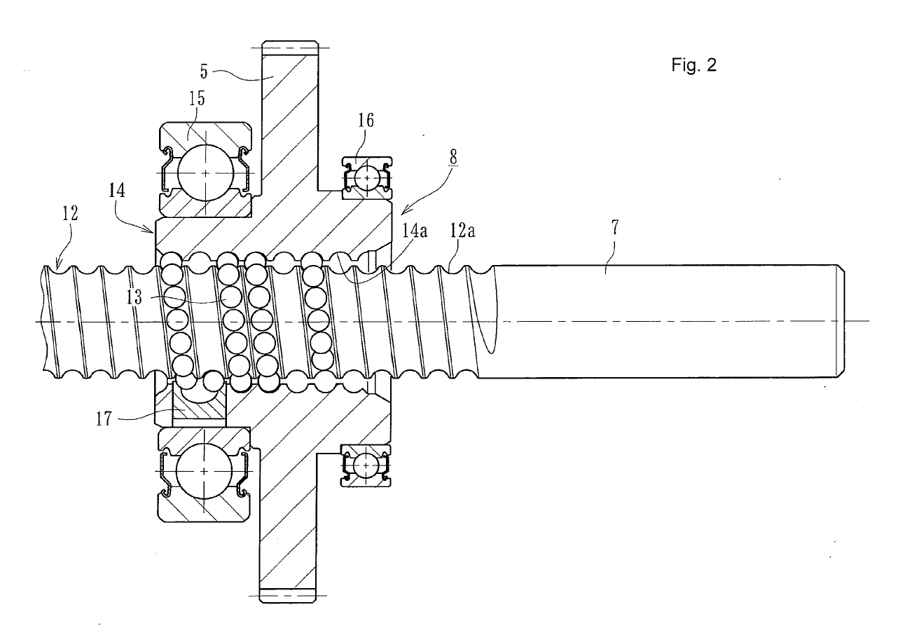

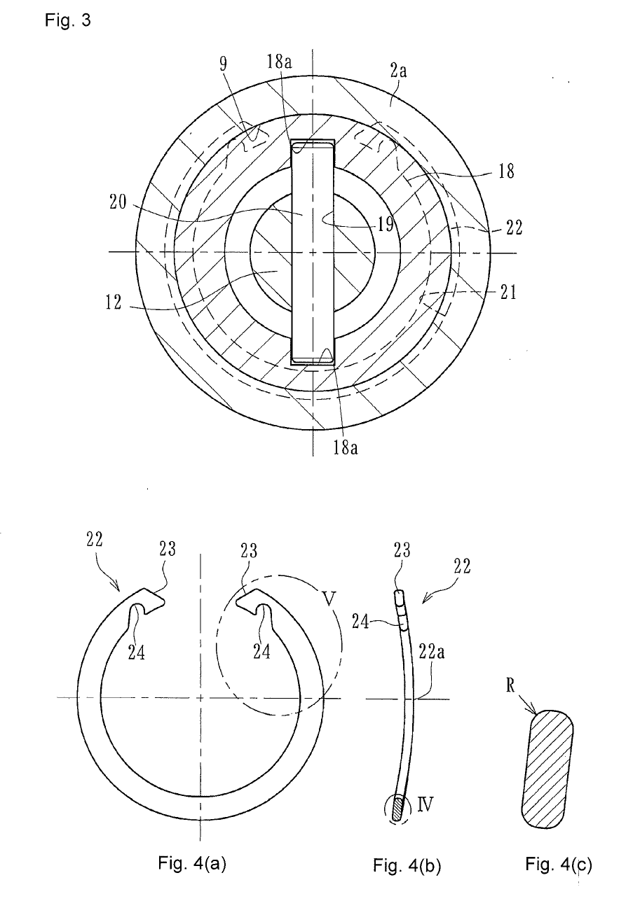

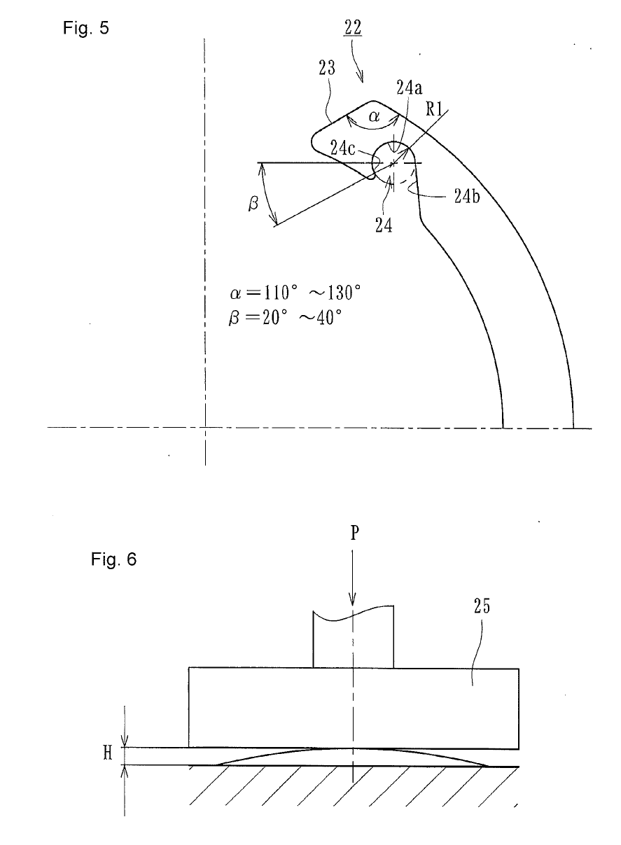

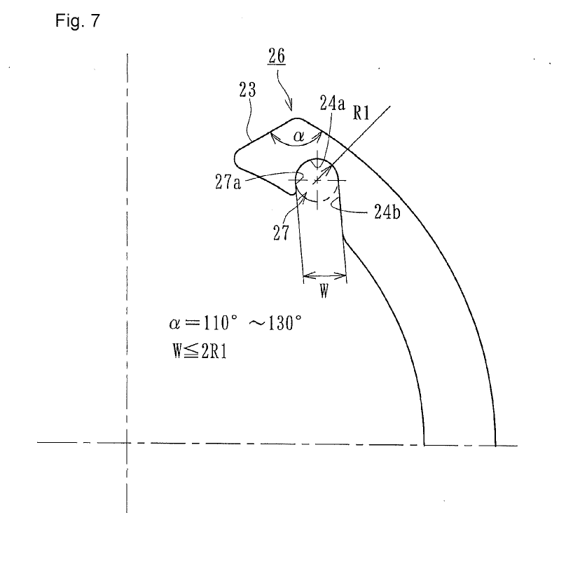

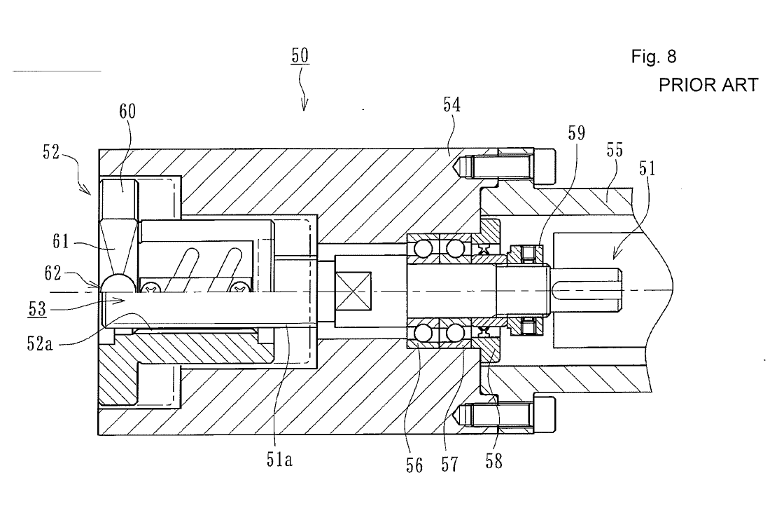

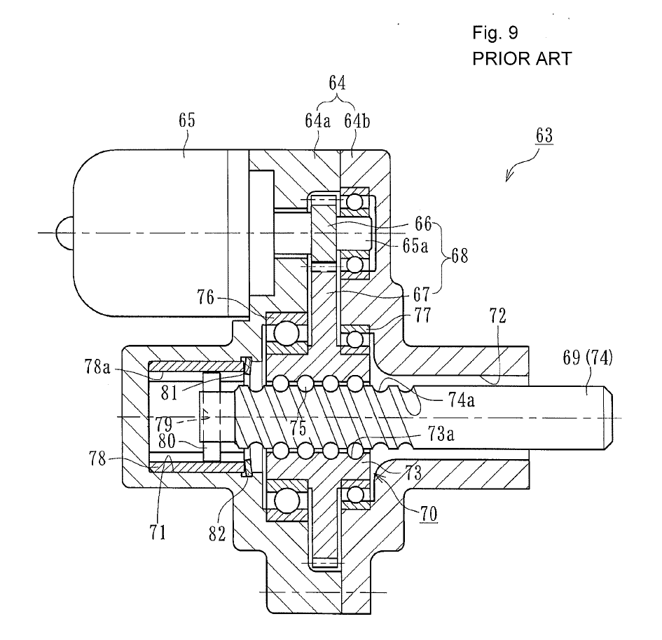

FIG. 1 is a longitudinal sectional view of one preferable embodiment of an electric actuator. FIG. 2 is an enlarged longitudinal sectional view of the ball screw mechanism of FIG. 1. FIG. 3 is a cross-sectional view taken along a line III-III of FIG. 1. FIG. 4(a) is a front elevation view of a stopper ring. FIG. 4(b) is a cross-sectional view of the stopper ring of FIG. 4(a). FIG. 4(c) is an enlarged view of a IV part of FIG. 4(b). FIG. 5 is an enlarged view of a V part of FIG. 4(a). FIG. 6 is an explanatory view of a method for measuring the axial spring load applied to the stopper ring. FIG. 7 is a partially enlarged view of a modification of the stopper ring of FIG. 5.

As shown in FIG. 1, the electric actuator 1 has a cylindrical housing 2, an electric motor 3 mounted on the housing 2, a speed reduction mechanism 6 and a ball screw mechanism 8. The speed reduction mechanism 6 has a pair of spur gears 4, 5 to transmit the rotational driving power of the motor 3, via its motor shaft 3a. The ball screw mechanism 8 converts rotational motion of the electric motor 3 to axial linear motion of a drive shaft 7, via the speed reduction mechanism 6.

The housing 2 is formed of aluminum alloy such as A 6063 TE, ADC 12 etc. The housing 2 has a first housing 2a and a second housing 2b abutted against and bolted to an end face of the first housing 2a. The electric motor 3 is mounted on the first housing 2a. The first housing 2a and the second housing 2b are formed with a blind bore 9 and a through bore 10, respectively, to accommodate the screw shaft 12.

The smaller spur gear 4 is press-fit onto the end of the motor shaft 3a of the electric motor 3. It is non-rotatably on the motor shaft 3a. The motor shaft is rotationally supported by a rolling bearing 11 mounted on the second housing 2b. The larger spur gear 5 mates with the smaller spur gear 4. The larger spur gear 5 is integrally formed with a nut 14 that forms part of the ball screw mechanism 8. The driving shaft 7 is coaxially integrated with the screw shaft 12 forming another part of the ball screw mechanism 8.

As shown in the enlarged view of FIG. 2, the ball screw mechanism 8 includes the screw shaft 12 and the nut 14. The nut 14 mates with the screw shaft 12, via balls 13. The screw shaft 12 outer circumference has a helical screw groove 12a. The screw shaft 12 is axially movably, but not rotationally supported on the housing 7. The nut 14 inner circumference has a helical screw groove 14a. The screw groove 14a corresponds to the screw groove 12a of the screw shaft 12. A large number of balls 13 are accommodated between the screw grooves 12a and 14a. The nut 14 is supported by two supporting bearings 15, 16. The nut is rotationally, but axially immovably, supported relative to the housings 2. The numeral 17 denotes a bridge member that connects opposite ends of the nut screw groove 14a to achieve an endless circulating passage of balls 13.

The cross-sectional configuration of each screw groove 12a, 14a may be either a circular-arc or a Gothic-arc configuration. However, the Gothic-arc configuration is adopted in this embodiment. It provides a large contacting angle with the ball 13 and sets a small axial gap. This provides a large rigidity against the axial load and thus suppresses the generation of vibration.

The nut 14 is formed of case hardened steel such as SCM 415 or SCM 420. Its surface is hardened to HRC 55˜62 by vacuum carburizing hardening. This enables the omission of operations such as buffing, for scale removal, after heat treatment and thus reduces the manufacturing cost. The screw shaft 12 is formed of medium carbon steel such as S55C or case hardened steel such as SCM 415 or SCM 420. Its surface is hardened to HRC 55˜62 by induction hardening or carburizing hardening.

The larger spur gear 5 is integrally formed with the outer circumference of the nut 14. The supporting bearings 15, 16 are press-fit onto the nut 14 at both sides of the larger spur gear 5, via a predetermined interference. This prevents an axial movement of the supporting bearings 15, 16 and the larger spur gear 5 even if a thrust load is applied to them. In addition, each supporting bearing 15, 16 include a deep groove ball bearing with mounted shield plates on both its sides. This prevents lubricating grease sealed within the bearing body from leaking outside. Also, it prevents abrasive debris from entering into the bearing body from the outside. The larger spur gear 5 may be formed separately from the nut 14 and secured on the nut 14 via a key.

In the illustrated embodiment, a cylindrical sleeve 18 is fit into the blind bore 9 of the first housing 2a. The sleeve 18 is formed from a sintered alloy by an injection molding machine for molding plastically prepared metallic powder. In this injection molding, metallic powder and binder, including plastics and wax, are firstly mixed and kneaded by a mixing and kneading machine to form pellets, from the mixed and kneaded material. The pellets are fed into a hopper of the injection molding machine. The pellets under a heated and melted state are pushed into dies and finally formed into the sleeve by a so-called MIM (Metal Injection Molding). The MIM method can easily mold sintered alloy material into article having desirable accurate configurations and dimensions even though the article require high manufacturing technology and has intricate configurations that are hard to form.

One example of a metallic powder for the sintering alloy able to be carburized is SCM415 including C of 0.13 wt %, Ni of 0.21 wt %, Cr of 1.1 wt %, Cu of 0.04 wt %, Mn of 0.76 wt %, Mo of 0.19 wt %, Si of 0.20 wt % and remainder Fe etc. The sleeve 18 is cementation quenched and tempered with controlling temperature. Other materials may be used for the sleeve 18. Examples are materials superior in workability and corrosion resistance and include Ni of 3.0˜10.0 wt % (FEN 8 of Japanese powder metallurgy industry standard) or stainless steel SUS 630 of precipitation hardening comprising C of 0.07 wt %, Cr of 17 wt %, Ni of 4 wt %, Cu of 4 wt %, remainder Fe etc. This stainless steel SUS 630 is able to properly increase its surface hardness to 20˜33 HRC by solid-solution heat treatment to obtain both the high toughness and hardness. It is possible to increase the strength and wear resistance of the sleeve 18 and thus its durability higher than those of the first housing 2a that is formed from aluminum alloy by adopting materials described above to the sleeve 18.

As shown in FIGS. 1 and 3, the inner circumference of the sleeve 18 is formed with a pair of axially extending recessed grooves 18a, 18a arranged radially opposed each other. A radially extending through aperture 19 is formed on the end of the screw shaft 12. A guide pin 20 is fit into the through aperture 19. The guide pin 20 engages the recessed grooves 18a, 18a. This axially guides and prevents rotation of the screw shaft 12. An annular groove 21 is formed on an opening of the blind bore 9. The sleeve is axially positioned and secured by a stopper ring 22 fit into the annular groove 21.

The guide pin 20 may be constituted by a needle roller, used in needle bearings, that is easily available at low cost with superior wear resistance and shear strength. More particularly, since the outer circumferential surface of the needle roller is crowned, it is possible to prevent edge load contact against the recessed grooves 18a, 18a of the sleeve 18. Thus, this improves the durability for a long term.

As described above, the guide pin 20 engages the recessed grooves 18a, 18a of the sleeve made of strong sintered alloy. Thus, it is possible to reduce the sliding friction and wear of the first housing 2a made of aluminum alloy. This further provides an electric actuator that has tough strength, a simple structure and can be manufactured at a low cost.

The stopper ring 22 is mounted in the annular groove 21 formed in the opening of the blind bore 9 of the first housing 2a. Axial movement of the sleeve 18 is prevented by abutment of the stopper ring 22 against the sleeve 18. The stopper ring 22 is formed of hard steel wire such as SWRH67A (JIS G3506). The stopper ring 22 has a configuration of an ended ring. Thus, it is deformable both in circumferential and radial directions as shown in FIG. 4(a). The stopper ring 22 inner circumference, near each of the two ends 23, 23 of the stopper ring 22, has a recess 24 that enables engagement of a tool (e.g. circlip plier). If the stopper ring 22 is elastically deformed, so as to reduce the outer diameter of its outer peripheral portion, by this tool inserted into the annular groove of the blind bore, it is secured by an elastic return force.

In addition as shown in FIG. 4(b), the stopper ring 22 has a curved portion 22a formed with at least one vertices (one vertex at the center of the stopper ring 22 in the illustrated embodiment) at positions symmetric about the notch. The sleeve is securely held under a pressed state by the stopper ring 22. Thus, the stopper ring 22 generates axial spring force against the sleeve 18 to apply a predetermined pre-pressure to the sleeve 18. This prevents the generation of noise or vibration of the housing 2. Furthermore, as shown in FIG. 4(c), four corner edges, of a cross-section of the stopper ring 22, are rounded to a radius R. This can be simply achieved without the necessity of after treatment if the stopper ring is press-formed from steel wires with corners that are previously rounded. Thus, mass productivity can be improved. The stopper ring 22 may be press-formed from austenitic stainless steel sheet (JIS SUS304 system) or preserved cold rolled steel sheet (JIS SPCC system) other than those described above.

As shown in the enlarged view of FIG. 5, an angle a of the radially outer side corner of the end 23 of the stopper ring 22 is formed with an obtuse angle. The obtuse angle may be between 110˜130°. This prevents the angled portion of the radially outer side corner of the end of the stopper ring 22 from being caught on the groove surface of the annular groove 21 of the housing 2a. Thus, this prevents the housing 2a from being damaged as well as it smoothly performs the removal operation of the stopper ring 22.

The recess 24 of the stopper ring 22 has a contour with a circular arc portion 24a. The circular arc portion has a predetermined radius of curvature R1. A flat portion 24b tangentially extends from the circular arc portion 24a. The circular arc portion 24a is larger than a semicircle. More particularly, an angle β formed between a horizontal line passing through the center of the circular arc portion 24a and a line passing through the center of the circular arc portion 24a and the edge of the opening 24c opposite to the flat portion 24b is within a range between 20°˜40°. This enables a tool to more easily engage the recess 24 and prevent the tool from easily slipping off from the stopper ring 22. Accordingly, this improves the workability.

The axial spring load of the stopper ring 22 is measured by sampling inspection as shown in FIG. 6. The axial spring load P is set at a value larger than 37 N at a height H (e.g. 2.2 mm) after compression to the thickness of the stopper ring 22 by measuring presser 25. This makes it possible to prevent the permanent set-in fatigue of the stopper ring 22 caused by repeated applied axial loads. Thus, this improves the reliability of the stopper ring 22.

A stopper ring 26 shown in FIG. 7 is a modification of the stopper ring 22 described above. This stopper ring 26 is different from the stopper ring 22 only in configuration of the opening 24c. Accordingly, the same reference numerals are used to identify the same parts in this modification as those in the stopper ring 22.

The stopper ring 26 is an ended ring deformable both in the circumferential and radial directions. It is press-formed from preserved cold rolled steel sheet. Its inner circumference, near each of both the ends 23, 23 of the stopper ring 26, includes a recess 27. The recess 27 has a contour with a circular arc portion 24a having a predetermined radius of curvature R1. A flat portion 24b tangentially extends from the circular arc portion 24a. The circular arc portion 24a is a semicircle. Each of portions of the opening 27a between a horizontal line passing through the center of the circular arc portion 24a and the edge of the opening 27a is formed by a flat surface. The width W of the opening 27a is set at a dimension equal to or smaller than 2R1 (W2R1). This enables a removing tool for the stopper ring to easily engage the recess 27 and prevent it from being disengaged from the stopper ring 26.

The present electric actuator can be used in general industry driving portions of an automobile etc. The electric actuator is provided with a ball screw mechanism to convert a rotational input motion from an electric motor to a linear motion of a drive shaft, via a speed reduction mechanism.

The present disclosure has been described with reference to the preferred embodiments. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. An electric actuator comprising:
a housing formed from aluminum light alloy;
an electric motor mounted on the housing;
a speed reduction mechanism for transmitting rotational driving power of the motor to a ball screw mechanism via a motor shaft;
the ball screw mechanism converts the rotational motion of the electric motor to an axial linear motion of a driving shaft, the ball screw mechanism further comprising a nut and a screw shaft, the nut has a helical screw groove on its inner circumference, the nut is rotationally supported by supporting bearings mounted on the housing, but is axially immovable relative to the housing, the screw shaft is coaxially integrated with the driving shaft, a helical screw groove is on an outer circumference of the screw shaft, the helical screw groove corresponds to the nut helical screw groove, the screw shaft is inserted into the nut, via a plurality of balls;
a cylindrical sleeve is fit into a blind bore formed in the housing to accommodate the screw shaft, the sleeve inner circumference has a pair of diametrically oppositely positioned axially extending recessed grooves to receive a guide pin mounted on one end of the screw shaft to guide the screw shaft so that it is able to move axially but not rotationally relative to the housing;
an annular groove is formed on an open end of the blind bore of the housing, the sleeve is axially immovably secured by a annular stopper ring fit into the annular groove;
the stopper ring has one notch and a recess is formed on an inner circumference of the stopper ring near each of two ends of the stopper ring to enable engagement of a detaching tool; and
a contour of each recess comprises a circular arc portion and a flat portion, the circular arc portion has a predetermined radius of curvature, the flat portion tangentially extends from the circular arc portion, a width of the opening of the recess is smaller than the diameter of the circular arc portion.

2. The electric actuator of claim 1, wherein the stopper ring has a curved portion formed with at least one vertex at positions symmetric about the notch and the sleeve is securely held under a pressed state by the stopper ring.

3. The electric actuator of claim 1, wherein the recess of the stopper ring circular arc is larger than a semicircle and an angle formed between a horizontal line passing through the center of the circular arc portion and a line passing through the center of the circular arc portion and the edge of the opening opposite to the flat portion is within a range of 20˜40°.

4. The electric actuator of claim 1, wherein the recess of the stopper ring comprises a semicircular arc portion and a flat portion extending tangentially from the semicircular arc portion and each of the portions of the opening between a horizontal line passing through the center of the semicircular arc portion and the edge of the opening is formed by a flat surface.

5. The electric actuator of claim 1, wherein an angle of the radially outer side corner of the end of the stopper ring is formed by an obtuse angle.

6. The electric actuator of claim 1, wherein the sleeve is formed of sintered alloy formed by Metal Injection Molding.
